(19) United States
(12) Patent Application Publication
(10) Pub. No.: US 2004/0086589 A1
(43) Pub. Date: May 6, 2004

(54) Positioning covering in a mould

(76) Inventor: Nick Siddall, Stortford Hertz (GB)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/470,482

(22) PCT Filed: Jan. 25, 2002
(86) PCT No.: PCT/GB02/00319

(30) Foreign Application Priority Data
Jan. 27, 2001 (GB) 0102201.1

(51) Int. Cl. B29C 44/14

(52) U.S. Cl. 425/127; 425/125; 425/817 R

(57) ABSTRACT

An apparatus comprising a mould (11) having a first mould part (20) and a second mould part (21), the second mould part (21) being movable relative to the first mould part (20), foam supply means to supply foam to said mould, and a positioning tool (10) for positioning a covering (14) in at least one of the first mould part (20) and the second mould part (21) wherein the positioning tool (0) is shaped to co-operate with aid at least one mould part, characterised in that the positioning tool (10) is provided with a groove (13) whereby a projecting part (18) of the covering (14) may be received in the groove (13).

### DESCRIPTION OF INVENTION

This invention relates to an apparatus comprising a mould and a tool for positioning a covering in the mould, a component and a method of making a component comprising a covering, particularly but not exclusively for providing a vehicle interior component.

When manufacturing components for vehicle interiors, a common processing technique referred to as “foam in place” is used, wherein a covering comprising a plastic moulded skin is placed in a foaming tool. A rigid armature is held spaced from the skin by the foaming tool and polyurethane foam is injected between the covering and the armature to provide a component with a soft feel foam interlayer supported by the armature. When manufacturing such a component, positioning of the moulded skin in the foaming tool is simple since the skin is formed in the shape of the final part and the foaming tool is appropriately shaped to receive the skin.

The use of leather or materials having the appearance of leather is becoming more common in vehicles. It is desirable to manufacture interior components with a covering of leather or material having the appearance of leather using the foam in place method. However, location of the covering in the mould is less simple than for a plastic moulded skin. This is particularly the case where the covering has a stitch line which should be aligned with a particular part of the component. Loading such a covering and aligning the stitch line requires a great deal of skill on the part of the operator to correctly align the stitch line. If the alignment of the stitch line is incorrect the part will be visually unacceptable, but since the likelihood of success is dependant on tool complexity and operator skill, an acceptable part is not guaranteed. It is also difficult to meet tight specifications on stitch line positioning tolerance.

An aim of the invention is to reduce or overcome one or more of the above problems.

According to a first aspect of the invention we provide an apparatus comprising a mould having a first mould part and a second mould part, the second mould part being movable relative to the first mould part, foam supply means to supply foam to said mould, and a positioning tool for positioning a covering in at least one of the first mould part and the second mould part wherein the positioning tool is shaped to co-operate with said at least one mould part, characterised in that the positioning tool is provided with a groove whereby a projecting part of the covering may be received in the groove.

The positioning tool may be shaped co-operate with said at least one mould part only in the vicinity of the groove.

The positioning tool may comprise a head part and a surface part extending away from said head part and wherein the groove is provided on the head part.

The positioning tool may be provided with first holding means to hold said covering adjacent the positioning tool.

The first holding means may comprise a vacuum holding means.

The at least one mould part may be provided with second holding means to hold said covering adjacent the at least one mould part.

The second holding means may comprise a vacuum holding means.

The apparatus may further comprise means to hold an armature spaced from the at least one mould part.

According to a second aspect of the invention we provide a component comprising a covering comprising an outer surface and an inner, reverse, surface which is bonded to a foam core wherein the covering comprises a stitch line, characterised in that the stitch line provides a projecting part on the reverse surface of the covering whereby the projecting part may be located in a groove of a positioning tool.

The covering may comprise a first part and a second part each having an outer surface, an edge part of each of the said first part and said second part being disposed adjacent one another such that the outer surfaces are in abutment and such that stitches pass through said edge part to form a stitch line.

The stitch line may further comprise a tape element extending along said stitch line on the reverse side of the covering, the tape element being attached to the first part and/or the second part either side of the stitch line.

The projecting part may comprise a profile held in place by said tape element.

The stitch line may be resistant to passage of foam.

According to a third aspect of the invention, we provide a method of making a component comprising a covering, the method comprising the steps of placing said covering on a positioning tool, locating said covering in a mould using said positioning tool, removing the positioning tool from the mould leaving the covering in place in the mould, closing the mould, and supplying foam to the mould, characterised in that the step of placing the covering on said positioning tool includes the step of locating a projecting part of said covering in a groove of said positioning tool.

The method may comprise the step, when the covering is placed on the positioning tool, of holding the covering in position adjacent the positioning tool by means of a first holding means.

The method may comprise the step, after inserting the positioning tool in the mould, of releasing the first holding means to release the covering from the positioning tool, and operating a second holding means to hold the covering in position in said mould.

The method may comprise the step of disposing an armature in the mould prior to closing the mould.

The invention will now be described by way of example only with reference to the accompanying drawings, wherein;

FIG. 1 is a perspective view of a positioning tool and covering,

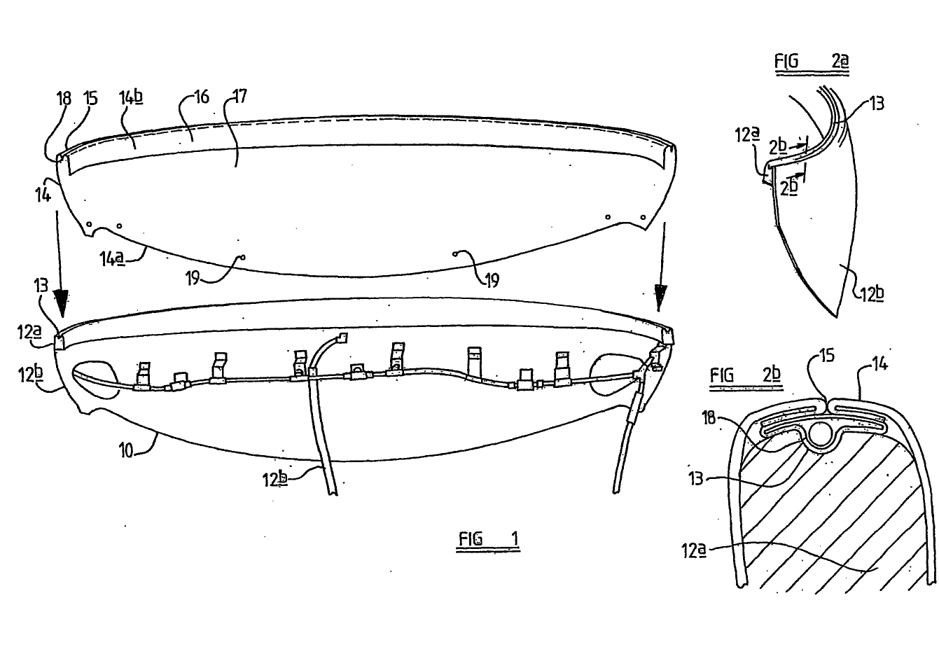

FIG. 2a is a perspective view of part of the positioning tool of FIG. 1,

FIG. 2b is a section on line 2b-2b of FIG. 2a where the positioning tool is provided with a covering,

FIG. 3 is a perspective view of a foaming tool,

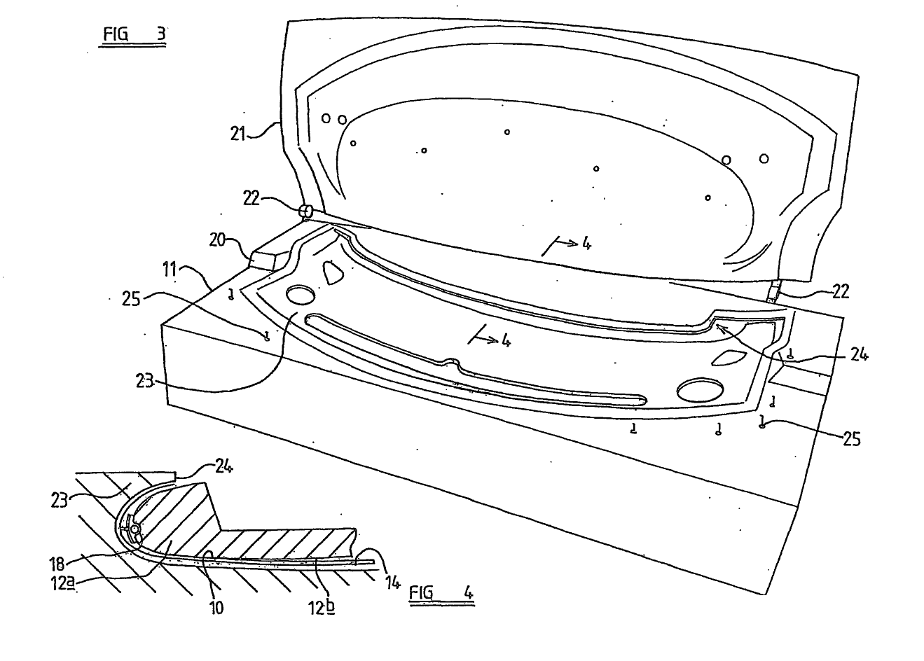

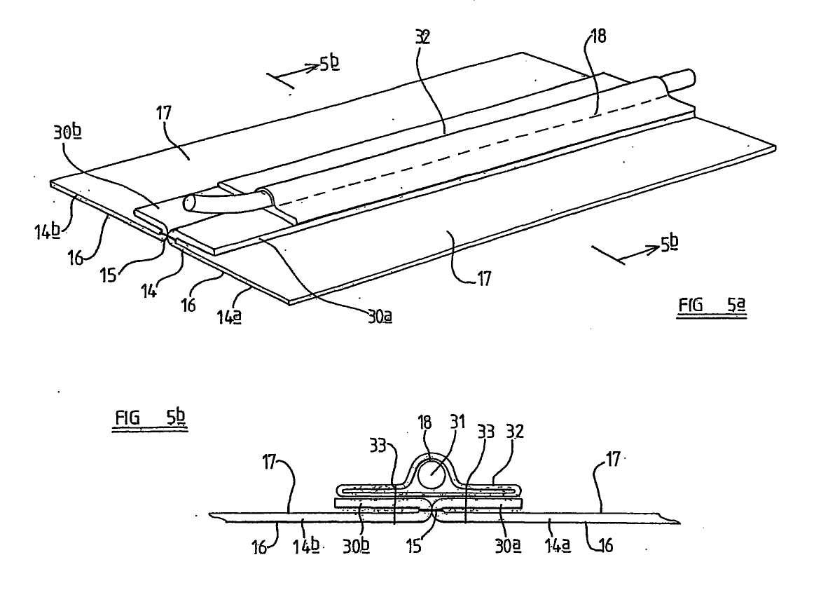

FIG. 4 is a section on line 4-4 of FIG. 3 further provided with a positioning tool of FIG. 1.

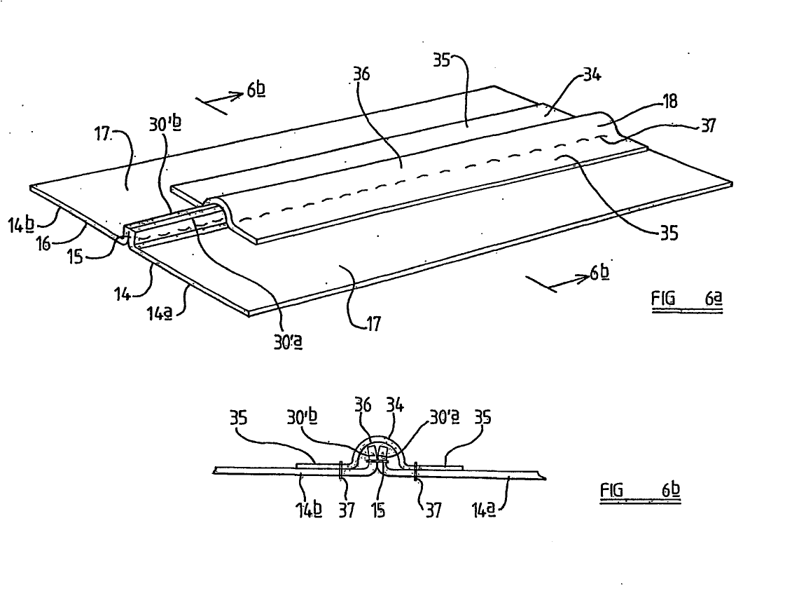

FIG. 5a is a perspective view of a stitch line of a covering according to the present invention,

FIG. 5b is a section on line 5-5 of FIG. 5a,

FIG. 6a is a perspective view of an alternative stitch line according to the present invention, and

FIG. 6b is a section on line 6-6 of FIG. 6a.

Referring now to FIGS. 1-4, a positioning tool according to the present invention is shown at 10, for use with a foaming tool generally indicated at 11 in FIG. 3. The positioning tool 10 comprises support means having a head part 12a and a surface part 12b, the surface part 12b being provided with first holding means 12c in the form of a vacuum source extending to apertures on the surface of the surface part 12b. The head part 12a along an edge thereof is provided with a recess 13, in the present example a groove extending along the length of the head part 12a. The positioning tool 10 is adapted to receive and support a covering 14 for location in the mould 11.

In the present example, the covering 14 comprises a first part 14a and a second part 14b, the first part 14a and second part 14b being joined along a stitch line 15. The stitch line 15 may be formed in any suitable manner as described, and particularly as described hereinafter. The covering 14 has an outer surface 16, which will be visible on the completed component, and an inner, or reverse, surface 17 which faces inwardly of the completed component. The covering 14 is mounted on the positioning tool 10 such that a projecting part 18 formed by the stitch line 15 is snugly received in the recess 13. The first part 14a of the covering 14 is disposed with the inner surface 17 adjacent the surface part 12b, such that when the first holding means 12c is operated, the covering 14 is held adjacent the surface part 12b. The covering 14 is further provided with a plurality of locating apertures 19 disposed towards the periphery thereof.

As shown in FIGS. 3 and 4, the foaming tool 11 comprises a lower mould part 20 and an upper mould part 21. In the present example, the upper mould part 21 is pivotally connected to the lower mould part 20 by hinges generally indicated at 22. A foam supply means (not shown) to supply foam to the foaming tool is provided. The lower mould part 20 is provided with a lower mould surface 23 in the shape of the outer surface of the desired component. In the particular example, the desired component forms part of a dashboard assembly for the interior of a vehicle. The lower mould surface 23 is provided with an undercut 24. As seen in FIG. 4, the head part 12a of the positioning tool 10 is shaped to conform to the shape of and be received within the undercut 24 of the lower mould surface 23, with allowances for the thickness of the covering 14. The lower mould surface 23 is provided with second holding means (not shown), for example vacuum means, to hold the covering 14 in place adjacent to the lower mould surface 23. The lower mould part 20 is further provided with a plurality of location pins 25 located around the periphery of the lower mould surface 23, the location pins 25 being adapted to engage the location holes 19 on the covering 14. The upper mould part 21 is provided with holding means (not shown) to support an armature at an appropriate spacing from the lower mould surface 23.

The support positioning tool 10 in the present example conforms to the shape of the lower mould surface 23 only in the vicinity of the recess 13, that is only the head part 12a is so shaped, to permit easy introduction and withdrawal of the positioning tool 10. It will be apparent that, where appropriate, the head part 12a may be provided without a recess 13, but the shape of the head part 12a will similarly advantageously permit easy location and withdrawal of the positioning tool 10.

To manufacture a component, an operator first places a covering 14 having a projecting part 18 onto the positioning tool 10 such that the projecting part 18 is received in the recess 13. By actuation of the holding means 12c, the covering 14 is held adjacent the positing tool 10 in the correct position. The operator then positions the positioning tool 10 in the lower mould part 21, such that the head part 12a of the positioning tool is received in the undercut 24. The operator locates the locating pins 25 in the corresponding locating holes 19 in the covering 14. If the holes and pins are not correctly aligned, this indicates that either the covering 14 or tool 10 is not correctly positioned, and then it will then be apparent to the operator that the tool 10 or the covering 14 needs to be repositioned.

Once the covering 14 and tool 10 are correctly positioned, the holding means of the lower mould part 21 are activated to hold the covering 14 in position adjacent the lower mould surface 23. The holding means 12c may then be deactivated, for example by releasing the vacuum, to release the covering 14 from the positioning tool 10. The positioning tool 10 may then be withdrawn from the lower mould part 21. The engagement of the pins 25 and holes 19 also helps to keep the covering 14 in place while the positioning tool 10 is withdrawn. The covering 14 is held in place with the outer surface 16 facing downwardly, adjacent the lower mould surface 23, and with the inner surface 17 facing upwardly.

In the present example, the geometry of the head part 12a of the positioning tool 10 and of the undercut 24 is such that the tool may be withdrawn from the mould without difficulty. When the geometry of the positioning tool 10 and/or lower mould part 21 is such that this may not be easily accomplished, the positioning tool 10 may be collapsible to permit easy removal of the tool 10 once the covering 14 has been positioned.

The effect of performing this method is that the stitch line 15 is correctly positioned relative to the lower mould part 23. The stitch line 15 can thus be repeatedly and easily located in the correct position without demanding a great deal of skill from the operator.

If the component is to comprise an armature, the armature is located on the upper mould part 21. A foaming material is dispersed directly on top of the covering 14 by the foam supply means. The tool 11 is then closed, by pivoting the upper part 21 of the mould about hinges 22 down to a closed position. The foaming tool 11 applies a desired pressure while the foaming material sets. Alternatively, the foaming tool 11 may be closed prior to introducing the foaming material, and foaming material introduced via the foam supply means. Where a armature is provided, the foaming material is introduced between the covering and armature. When the foaming material has set, the component, now comprising a covering 14 bonded to an armature by a layer of foam material, may be withdrawn from the tool 11 and the process repeated.

If desired, further positioning means such as hinge or dowels may be provided to locate the positioning tool 10 relative to the lower mould part 23. Alternatively, where the geometry of the lower mould part 23 and positioning tool 10 are such that the positioning tool 10 can only be located in one position the lower mould part 23, then the dowels or other means may be omitted.

The method and apparatus are intended to be used with leather or material having the appearance of leather such as leatherette, although other material where suitable may be used as desired.

For the covering 14 to be correctly located on the positioning tool 10, it is of course necessary that the projecting part 18 of the stitch line 15 be of a suitable size and shape to be correctly received within the recess 13. Examples of two such projecting parts are shown in FIGS. 5a, 5b, 6a, 6b.

In the first example, as shown is FIGS. 5a, and 5b, the two parts 14 14b, of the covering 14 are joined at a stitch line 15. The first part 14a and second part 14b are joined together along the stitch line 15 such that the selvage 30a, 30b of each part, i.e. that edge part of the material extending beyond the stitch line 15, will be disposed within the final component out of view, adjacent to the inner surface 17. Disposed above the stitch line 15 and running parallel thereto is a profile, in the present example comprising a length of piping 31. The profile may alternatively comprise rope, or wire, or may be other material as appropriate or desired. The length of piping 31 is held in place by a tape envelope 32 which extends alongside the stitch line 15. The piping 31 is disposed within a generally central part of the envelope 32. The envelope 32 is then held in place by stitch lines 33 extending either side of the piping 31 and passing through the envelope 32 and at least one of the first part 14a and second part 14b as appropriate. Hence, a projecting part 18 is formed on the inner, or reverse, surface 17 of the covering 14 which may be received in the recess 13.

In an alternative configuration, where the material of the covering 14 is sufficiently thick, the piping may be omitted as shown in FIGS. 6a and 6b. In this example, the parts 14a and 14b are likewise joined by a stitch line, but instead of being folded back to lie alongside the parts 14a, 14b, the selvage 30′a, 30′b as seen in FIGS. 6b extends generally transverse to the part 14a, 14b. A tape part 34 is disposed on the inner surface 17 of the part 14, a side part 35 of the tape 34 disposed each side of the stitch line 15 and lying adjacent to the part 14a, 14b, with a central part 36 of the tape 34 extending over the stitch line 15. The tape 34 is then held in place by stitch lines 37 passing through at least one of the first part 14a and second part 14b either side of the stitch line 15.

In addition to providing a projecting part 18, a stitch line 15 as described hereinbefore has the further advantage that when the covering 14 is located in the foaming tool 11 and foam is supplied to the mould, the stitch line 15, and in particular the tape element 34, resists the passage of foam through the stitch line 15.

It will be apparent that the feature 18 may be formed by any means as desired. It will also be apparent that the method and apparatus may be used to manufacture any appropriate component as desired and may be applied to location of a covering in a mould for any application of purpose as necessary.

In the present specification “comprise” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. An apparatus comprising a mould (11) having a first mould part (20) and a second mould part (21), the second mould part (21) being movable relative to the first mould part (20), foam supply means to supply foam to said mould, and a positioning tool (10) for positioning a covering (14) in at least one of the first mould part (20) and the second mould part (21) wherein the positioning tool (10) is shaped to co-operate with said at least one mould part, characterised in that the positioning tool (10) is provided with a groove (13) whereby a projecting part (18) of the covering (14) may be received in the groove (13).

2. An apparatus according to claim 1 wherein the positioning tool (10) is shaped co-operate with said at least one mould part only in the vicinity of the groove (13).

3. An apparatus according to claim 1 or claim 2 wherein the positioning tool (10) comprises a head part (12a) and a surface part (12b) extending away from said head part (12a) and wherein the groove (13) is provided on the head part (12a).

4. An apparatus according to any one of claims 1 to 3 wherein the positioning tool (10) is provided with first holding means to hold said covering adjacent the positioning tool.

5. An apparatus according to claim 4 wherein the first holding means comprises a vacuum holding means.

6. An apparatus according to any one of the preceding claims wherein the at least one mould part is provided with second holding means to hold said covering adjacent the at least one mould part.

7. An apparatus according to claim 6 wherein the second holding means comprises a vacuum holding means.

8. An apparatus according to any one of the preceding claims further comprising means to hold an armature spaced from the at least one mould part.

9. An apparatus substantially as described herein and/or with reference to the accompanying drawings.

10. A component comprising a covering (14) having an outer surface (16) and an inner, reverse surface (17) which is bonded to a foam core wherein the covering (14) comprises a stitch line (15), characterised in that the stitch line (15) provides a projecting part (18) on the reverse surface of the covering whereby the projecting part (18) may be located in a groove (13) of a positioning tool (10).

11. A component according to claim 10 wherein the covering (14) comprises a first part (14a) and a second part (14b) each having an outer surface, an edge part (30a, 30b) of each of the said first part and said second part being disposed adjacent one another such that the outer surfaces are in abutment and such that stitches pass through said edge part to form a stitch line (15).

12. A component according to claim 11 wherein the stitch line (15) further comprises a tape element (34) extending along said stitch line on the reverse side of the covering, the tape element (34) being attached to the first part (14a) and/or the second part (14b) either side of the stitch line (15).

13. A component according to claim 12 wherein the projecting part comprises a profile (31) held in place by said tape element (34).

14. A component according to claim 12 or claim 13 wherein the stitch line (15) is resistant to passage of foam.

15. A component as described herein and/or with reference to the accompanying drawings.

16. A method of making a component comprising a covering (14), the method comprising the steps of placing said covering (14) on a positioning tool (10), locating said covering in a mould (11) using said positioning tool (10), removing the positioning tool (10) from the mould (11) leaving the covering (14)in place in the mould (11), closing the mould (11), and supplying foam to the mould (11), characterised in that the step of placing the covering (14) on said positioning tool (10) includes the step of locating a projecting part of said covering (14) in a groove of said positioning tool (10).

17. A method according to claim 16 comprising the step, when the covering (14) is placed on the positioning tool, of holding the covering (14) in position adjacent the positioning tool by means of a first holding means.

18. A method according to claim 17 comprising the step, after inserting the positioning tool in the mould (11), of releasing the first holding means to release the covering (14) from the positioning tool, and operating a second holding means to hold the covering (14) in position in said mould (11).

19. A method according to any one of claims 16 to 18 comprising the step of disposing an armature in the mould (11) prior to closing the mould (11).

20. A method substantially as described herein and/or with reference to the accompanying drawings.

21. Any novel feature or novel combination of features described herein and/or in the accompanying drawings.
